(19) United States
(12) Patent Application Publication
(10) Pub. No.: US 2003/0126273 A1
(43) Pub. Date: Jul. 3, 2003

(54) Prefix-based systems, methods and access tools for accessing information on the internet

(76) Inventor: Mary E. Goulet, Falls Church, VA (US)

Correspondence Address: WORLDSAWAYMUSICAL.com, 7025-H Haycock Road, Falls Church, VA, 22043, US

(21) Appl. No.: 10/035,279

(22) Filed: Jan. 3, 2002

(51) Int. Cl. G06F 15/16

(52) U.S. Cl. 709/230; 709/245

(57) ABSTRACT

A tool for accessing content on the Internet is provided. In a cooperating Internet system, a unifying prefix (such as a word, such as “urgent”, a school name, etc.) is used. A posted Internet website is accessible via an Internet domain name that begins with www. followed by the unifying prefix followed by a topic word or phase.

### FIELD OF THE INVENTION

The invention generally relates to the Internet, especially to accessing information on the Internet.

### BACKGROUND OF THE INVENTION

One way that users access content on the Internet (or World Wide Web) is when they already have been told the domain name address (such as noting the address www.worldsawaymusical.com on a “Worlds Away” compact disk or promotional beach towel) and they decide to access the website via the address. However, in many situations the user does not know a specific website domain name address, or even that a website may exist that may be of interest to him or her.

Over time, Internet domain names seem to have naturally gotten longer as the “words” followed by a “.com” suffix were taken. To accommodate demand, over time, other suffixes were added, such as “.tv”.

A vast amount of content is posted on the Internet. The main tool available to Internet users is a search engine, such as google.com. However, simple searching via such a search engine still results in an enormous amount of content for many searches. For example, in the case of typing the word “music” into the Google search engine, over 52 million hits are returned. For other typed words, the hits returned are as shown in the following Table 1:

TABLE 1

| | | |
|---|---|---|
| “book” | >46 | million hits |
| “author” | >45 | million |
| “singer” | >2.6 | million |
| “artist” | >3 | million |
| “accountant” | 968,000 | |
| “beach” | >13 | million |
| “vacation” | >6 | million |
| “inn” | >3 | million |
| “gift idea” | >1 | million |
| “baby gift” | >1 | million |
| “educational toy” | 216,000 | |
| “educational game” | 814,000 | |
| “jewelry” | >6 | million |

With such a vast amount of content returned, the content is unlikely to present itself with content of highest interest to the user at the top of the list. Going through long lists requires too much work, and many websites that may have been of interest to the user remain unseen. With existing search engines like google.com, narrowing searches (including learning search conventions), requires time and effort, may not reach content of interest, and/or still may fail to produce a list of content ordered with the content of most interest to the user at the top.

### SUMMARY OF THE INVENTION

It therefore is an object of this invention to provide a tool for accessing content on the Internet, in which a user, without knowing a certain Internet domain address, may formulate an Internet domain name likely to directly access content sought by the user that the user may directly enter.

In order to accomplish these and other objects of the invention, the present invention in a first preferred embodiment provides a cooperating Internet system comprising: a posted Internet website accessible via a first Internet domain name that begins with www. followed by a unifying prefix followed by a first topic phrase, wherein the unifying prefix is included in at least a second Internet domain name that begins with www. followed by the unifying prefix followed by a second topic phrase, wherein the posted content accessible via the first Internet domain name and via the second Internet domain name follow at least one unifying rule.

The invention in a second preferred embodiment provides a method of advertising services and/or products on the Internet, comprising: (A) establishing a unifying prefix; (B) obtaining at least one domain name beginning with www. followed by the unifying prefix; and (C) publicizing the unifying prefix.

In a third preferred embodiment, the invention provides a unified system of organizing information posted on the Internet, comprising: establishing and publicizing a directory, wherein the directory includes at least a first unifying prefix 1 and n−1 further unifying prefixes, where n is any integer ≧1, wherein at least the unifying prefix 1 appears in at least one Internet domain name via which posted content is accessible in a form beginning www.“unifying prefix 1”. In such inventive unified systems, optionally n may be ≧2 and the directory may include at least further “unifying prefix 2”; wherein the “unifying prefix 2” appears in at least one Internet domain name via which posted content is accessible in a form beginning www. “unifying prefix 2”. The “unifying prefix 1” may appear in a plurality of registered Internet domain names and the “unifying prefix 2” may appear in a plurality of registered Intern et domain names.

The invention in a fourth preferred embodiment provides a tool for accessing content on the Internet, comprising: a unifying prefix applicable in a domain name form of “www.” followed by the unifying prefix followed by a topic phrase followed by a suffix (such as “.com”).

Some details of the inventive systems, methods and tools, without the invention being limited thereto, are as follows. The unifying prefix may be included in a plurality of domain names beginning with the unifying prefix. There may be included in the inventive systems and methods a plurality of domain names that begin with www. followed by the unifying prefix followed by respectively differing topic phrases. The unifying prefix may be advertised and/or announced. The unifying prefix may be a school name, an association name, a club name, a hobby, a sport, a word, etc. The unifying prefix may be established in connection with a unifying suffix (such as “.com”). Inventive systems and methods may include obtaining a series of domain names beginning with the unifying prefix; posting content on respective websites for a series of domain names each beginning with the unifying prefix; obtaining a series of domain names beginning with the unifying prefix and ending with a unifying suffix; and/or posting content on respective websites for a series of domain names each beginning with the unifying prefix and ending with the unifying suffix.

### BRIEF DESCRIPTION OF THE DRAWINGS

The foregoing and other objects, aspects and advantages will be better understood from the following detailed description of the preferred embodiments of the invention with reference to the drawings, in which:

FIG. 1 is a block diagram of an exemplary Internet domain name according to the invention.

FIG. 2 is a block diagram of an exemplary cooperating Internet domain name system according to the invention.

FIG. 3 is a flow-chart of an exemplary unifying prefix system according to the invention.

### DETAILED DESCRIPTION OF PREFERRED EMBODIMENTS OF THE INVENTION

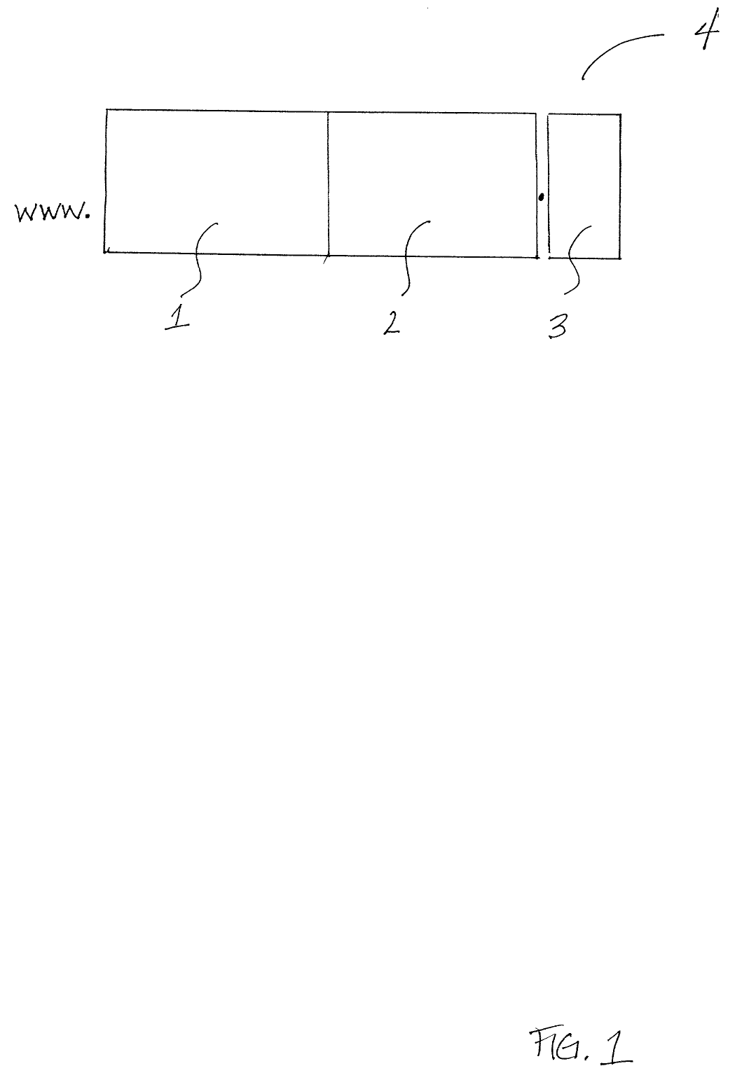

In a preferred embodiment of the invention, seen with respect to FIG. 1, a unifying prefix 1 useable in accessing content on the Internet is established. As a unifying prefix 1 may be used any string of two or more characters readable as an Internet domain name, preferably a period-free and hyphen-free string of two or more characters, preferably a string of two or more characters forming a word (such as “urgent”, “tennis”, etc.) or words (such as “john carroll”, etc.) or abbreviation (such as “jc” for The John Carroll School; “jhu” for The Johns Hopkins University, etc.). Most preferably, the unifying prefix 1 is established in connection with a single unifying suffix 3 (such as “.com”, etc.) as a unifying framework (such as a “www.urgent_.com” framework; a “www.tennis_.com” unifying framework; a “www.jc_.com” unifying framework; a “www.jhu_.com” unifying framework, etc.). As a prefix also may be mentioned a school followed by a graduation year (such as “jc83” or “jhu86”). It will be appreciated that many Internet names in the form www. followed by a word or phrase followed immediately by a suffix (such as .com) are unavailable for purchase. The present invention does not require that all posted websites with domain names beginning with the unifying prefix be commonly owned or controlled.

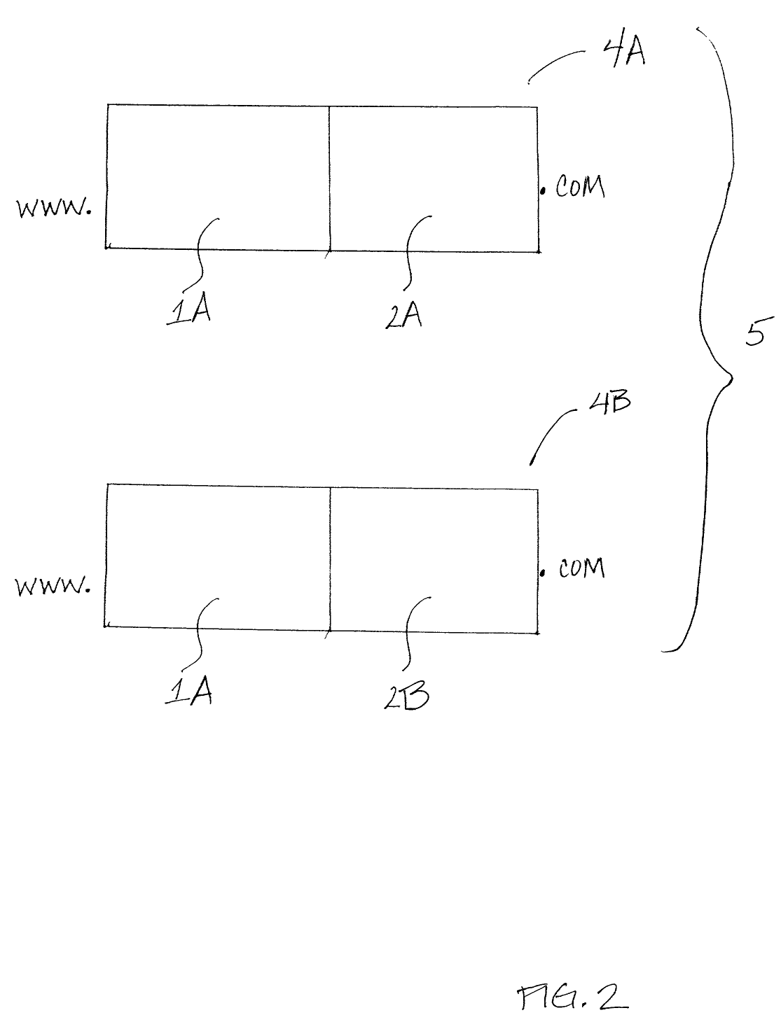

As an example of establishing a unifying prefix may be mentioned the purchase of at least one domain name 4 beginning with www. followed immediately by the prefix 1, such as purchasing a domain name through www.nsi.com. A cooperating series of domain names 4 may be obtained (such as purchased), each domain name 4 in the series having a common unifying prefix 1, most preferably each domain name 4 in the series having a common unifying framework consisting essentially of a common unifying prefix 1 and a common suffix 3. An exemplary cooperating series 5 of domain names 4A, 4B is shown in FIG. 2, with the domain names 4A, 4B sharing a unifying prefix 1A and sharing a suffix “.com”. As seen with reference to FIGS. 1 and 2, a domain name 4 (such as domain names 4A, 4B) include a variable topic phrase 2 which in the first domain name 4A is a first topic phrase 2A and in the second topic phrase 4B is a second topic phrase 2B that differs from the first topic phrase 2A.

A topic phrase 2 according to the invention is not particularly limited, and preferably is a word or phrase (without spaces), e.g., “patent”, “trademark”, “computer”, “ITC”, “technology”, “securities”, “Virginia”, “Maryland”, “copyright”, “vacation”, “beach”, “antique”, “art”, “music”, “book”, “CD”, “play”, “record”, “show”, a highly-used Internet search term, etc.

By a group (such as a graduating class, alumni association, etc.), establishing a unifying prefix, its members can more readily access each other to do business with each other, network, etc. For example, a consumer may have no reason to know that a fellow alumni that he never met (such as someone 5 years his junior or senior, etc.) or someone he met in school but with whom contact was not maintained, now runs a vacation resort or an inn. However, if he is thinking of a vacation generally but has not settled on a destination, may be interested to try the spot upon learning of it by typing an easy domain name including the unifying prefix followed by a topic phrase such as “vacation” or “inn”.

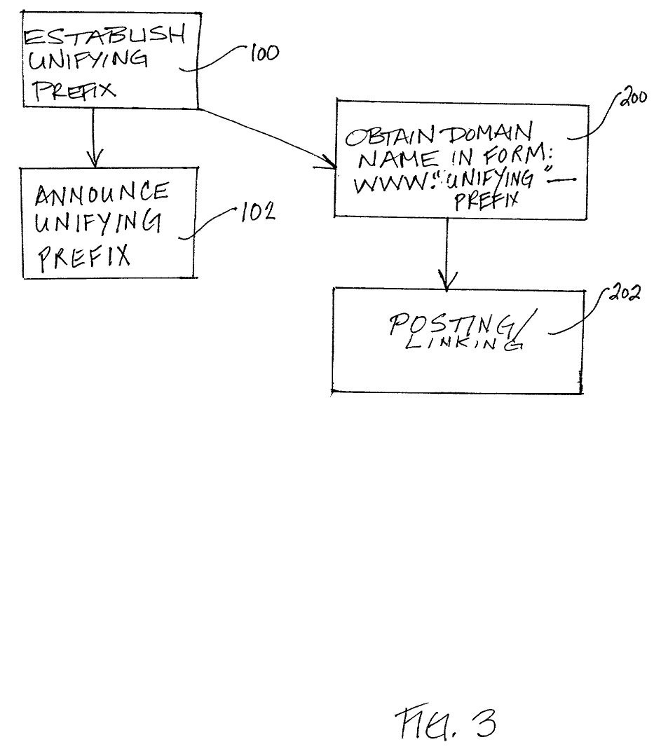

According to the invention, a unifying prefix that has been established preferably is announced. Announcing a unifying prefix is not particularly limited, and there may be mentioned press releases, submissions to school newsletters and alumni magazines, paid advertisements, written correspondence, etc. An exemplary unifying prefix system according to the invention is shown in FIG. 3, wherein the system comprises establishing a unifying prefix (100) and announcing the unifying prefix (102), further including obtaining a domain name in the form www.“unifying prefix”—(200) and posting/linking (202) to content on the website accessible via the www.“unifying prefix”-. The content may be newly posted, or the content may be on an existing operational website and a link provided. For an existing operational website (such as www.worldsawaymusical.com), its accessibility may be increased by obtaining one or more domain names each including an appropriate unifying prefix, and directly routing accesses via the unifying prefix domain names to the existing operational website.

For a unifying prefix according to the invention, preferably a unifying rule is announced for posted content on a website accessible by a domain name beginning with www. followed by the unifying prefix. A unifying rule is not particularly limited, and examples of a unifying rule include: that the first page of the posted content of websites to which the rule applies bear an individual's name, telephone number, email contact information (and, preferably, business or professional information); that the posting or linking individual be a member of or be affiliated with a particular group, organization, etc. (with the rule optionally requiring or not requiring said membership or affiliation to be indicated in the posted website content); that the posting or linking individual enjoy the hobby, pastime or sport indicated by the unifying prefix; etc.

Optionally, when multiple unifying prefixes are established and have posted content accessible via a domain name beginning with www. followed by each respective unifying prefix, then a directory of unifying prefixes is established (such as a website posting of unifying prefixes for which posted content is available). For each unifying prefix that is listed in the directory, optionally a browsing list may be provided of Internet domain names in which the unifying prefix appears and for which there is posted content meeting a unifying rule applicable to the unifying prefix. For a unifying prefix included in a directory, any applicable unifying rule may be provided. Most preferably, the directory lists each unifying prefix in the form of a unifying framework comprising a unifying prefix and a shared suffix (most preferably a unifying prefix combined with a “.com” suffix). An exemplary directory of unifying frameworks is shown in the following Table 2.

TABLE 2

jc_{—————}.com
jhu_{————}.com
urgent_{———}.com
urichmond_.com
uva_{————}.com
yale_{————}.com

Optionally, a directory according to the invention may contain announcements (such as lists) of any topic phrase that, when entered following a prefix (or, most preferably, in conjunction with a unifying framework) listed in the directory, will access posted content.

When using a unifying prefix and a topic word or phrase according to the present invention, an Internet searcher advantageously may be able to access a posted web site that answers his or her objective without using a conventional search engine like google.com and with a minimal amount of typing and clicking. In cases where formulating a domain name to enter using the inventive prefix system produces no site or no site of interest, or where the searcher simply wants to compile more information, resort easily can be made to conventional searching.

A unifying prefix “urgent” is established, with an “urgentpatent.com” website, an “urgenttrademark.com” website and other “urgent”-websites. The “urgentpatent.com” website posted content includes the term “urgentpatent”, so that “urgentpatent” typed by a searcher in a conventional search engine yields the “urgentpatent.com” site. The “urgenttrademark.com” website posted content includes the term “urgenttrademark”, so that “urgenttrademark” type by a searcher yields the “urgenttrademark.com” site.

### EXAMPLE 1

The Internet domain name “www.urgentpatent.com” was purchased and website content was posted. Subsequently, “urgent” was identified as a prefix and a cooperating series of Internet domain names was purchased including:

www.urgenttrademark.com

www.urgentcomputer.com

www.urgentITC.com

www.urgenttechnology.com

www.urgentsecurities.com

www.urgentcopyright.com

### EXAMPLE 2

In Example 1, “www.urgent_.com” is established as a framework, with an applicable rule that content comprising an individual's name, telephone number, email contact information and summary professional, business and/or career information be viewable on the first page of a website accessed by the “www.urgent_.com” framework.

### EXAMPLE 3

The availability of “urgent” as a unifying prefix and Internet access tool is announced by print advertising. A consumer wanting to reach a patent attorney, without using a search engine such as “google”, directly accesses “www.urgentpatent.com”.

### EXAMPLE 4

A unifying prefix “urgent” is established, with an “urgentpatent.com” website and other “urgent”-websites. The “urgentpatent.com” website posted content includes the term “urgentpatent”, so that “urgentpatent” typed by a searcher in a google.com or other search engine yields the “urgentpatent.com” site (providing the site has been registered with, or picked up by, google.com or the other search engine).

While the invention has been described in terms of its preferred embodiments, those skilled in the art will recognize that the invention can be practiced with modification within the spirit and scope of the appended claims.

I claim:

1. A cooperating Internet system comprising:
a posted Internet website accessible via a first Internet domain name that begins with www. followed by a unifying prefix followed by a first topic phrase, wherein the unifying prefix is included in at least a second Internet domain name that begins with www. followed by the unifying prefix followed by a second topic phrase,
wherein the posted content accessible via the first Internet domain name and via the second Internet domain name follow at least one unifying rule.

2. The cooperating Internet system of claim 1, wherein the unifying prefix is included in a plurality of domain names beginning with the unifying prefix.

3. The cooperating Internet system of claim 1, wherein the first domain name and the second domain name have a dot-com suffix.

4. The cooperating Internet system of claim 1, further including a plurality of domain names that begin with www. followed by the unifying prefix followed by respectively differing topic phrases.

5. The cooperating Internet system of claim 1 wherein the unifying prefix is advertised and/or announced.

6. The cooperating Internet system of claim 1, wherein the unifying rule is that the first page of posted content include an individual's name, business or professional information, telephone number and email contact information.

7. The cooperating Internet system of claim 1, wherein the unifying prefix is an English-language word.

8. The cooperating Internet system of claim 1, wherein the unifying prefix is the word “urgent”.

9. The cooperating Internet system of claim 1, wherein the unifying prefix is selected from the group consisting of a school name, an association name, a club name, a hobby and a sport.

10. The cooperating Internet system of claim 1, wherein the unifying prefix is established in connection with a unifying suffix.

11. A method of advertising services and/or products on the Internet, comprising:
(A) establishing a unifying prefix;
(B) obtaining at least one domain name beginning with www. followed by the unifying prefix; and
(C) publicizing the unifying prefix.

12. The method of claim 11, including obtaining a series of domain names beginning with the unifying prefix.

13. The method of claim 11, including posting content on respective websites for a series of domain names each beginning with the unifying prefix.

14. The method of claim 11, including obtaining a series of domain names beginning with the unifying prefix and ending with a unifying suffix.

15. The method of claim 11, including posting content on respective websites for a series of domain names each beginning with the unifying prefix and ending with the unifying suffix.

16. A unified system of organizing information posted on the Internet, comprising:
establishing and publicizing a directory, wherein the directory includes at least a first unifying prefix 1 and n−1 further unifying prefixes, where n is any integer≧1, wherein at least the unifying prefix 1 appears in at least one Internet domain name via which posted content is accessible in a form beginning www.“unifying prefix 1”.

17. A unified system according to claim 16, wherein n≧2 and the directory includes at least further “unifying prefix 2”;
wherein the “unifying prefix 2” appears in at least one Internet domain name via which posted content is accessible in a form beginning www. “unifying prefix 2”.

18. A unified system according to claim 16, wherein the “unifying prefix 1” appears in a plurality of registered Internet domain names and the “unifying prefix 2” appears in a plurality of registered Internet domain names.

19. A unified system according to claim 16, wherein the “unifying prefix 1” appears in a plurality of registered Internet domain names for which content may be accessible or for which content may be not posted or not accessible.

20. A tool for accessing content on the Internet, comprising:
a unifying prefix applicable in a domain name form of “www.” followed by the unifying prefix followed by a topic phrase followed by a suffix.
